(19) United States
(12) Patent Application Publication
(10) Pub. No.: US 2004/0153014 A1
(43) Pub. Date: Aug. 5, 2004

(54) Method and apparatus for rubbing hair and other objects

(76) Inventor: James R. Sage JR., Cyclone, PA (US)

Correspondence Address: Ansel M. Schwartz, Suite 304, 201 N. Craig Street, Pittsburgh, PA, 15213, US

(21) Appl. No.: 10/356,903

(22) Filed: Feb. 3, 2003

(51) Int. Cl. A61H 9/00

(52) U.S. Cl. 601/159

(57) ABSTRACT

A shampooer for shampooing hair. The shampooer includes a housing having a chamber in which fluid is stored, a first hole through which the fluid in the chamber can flow, and at least a second hole. The shampooer includes a door disposed in the chamber over the first hole which closes the first hole when the door is in a closed state and opens the first hole for fluid from the chamber to pass through when the door is in an open state. The shampooer includes an activator disposed on the housing that extends through the second hole to the door, when the activator is in a depressed state, the door is in the open state and when the activator is in an undepressed state, the door is in the closed state. The shampooer includes a head attached to the housing adjacent the first hole for rubbing the hair. A method for shampooing hair.

### FIELD OF THE INVENTION

The present invention is related to a shampooer for shampooing the hair. More specifically, the present invention is related to a shampooer for shampooing the hair where the shampoo is dispensed by the push of a button while the shampooer rubs the hair.

### BACKGROUND OF THE INVENTION

A common technique to shampoo hair is to place shampoo on the hair, on the hand, and then rub the hair with the shampoo to cleanse the hair. If more shampoo is needed, more shampoo must be poured on the head or the hand. Additionally, it is invigorating to the hair and underlying skin to rub the hair. The present invention provides for the user to rub the hair while having a supply of shampoo available for dispensing while rubbing the hair.

### SUMMARY OF THE INVENTION

The present invention pertains to a shampooer for shampooing hair. The shampooer comprises a housing having a chamber in which fluid is stored, a first hole through which the fluid in the chamber can flow, and at least a second hole. The shampooer comprises a door disposed in the chamber over the first hole which closes the first hole when the door is in a closed state and opens the first hole for fluid from the chamber to pass through when the door is in an open state. The shampooer comprises an activator disposed on the housing that extends through the second hole to the door, when the activator is in a depressed state, the door is in the open state and when the activator is in an undepressed state, the door is in the closed state. The shampooer comprises a head attached to the housing adjacent the first hole for rubbing the hair.

The present invention pertains to a method for shampooing hair. The method comprises the steps of depressing a button disposed on a housing to a depressed date which causes a stem that extends from the button through a second hole in the housing through a chamber in the housing to a door to move the door to an open state and open a first hole in the chamber. There is the step of introducing soap into the chamber through the first hole. There is the step of releasing the button causing the button to move to an undepressed state, and the stem to move the door to a closed state which seals the first hole and prevents the soap in the chamber from flowing through the first hole. There is the step of placing the housing on the hair. There is the step of depressing the button to move the door to the open state and allow soap in the chamber to flow through the first hole and out to the hair. There is the step of moving the housing against the hair.

### BRIEF DESCRIPTION OF THE DRAWINGS

In the accompanying drawings, the preferred embodiment of the invention and preferred methods of practicing the invention are illustrated in which:

FIG. 1 is a schematic representation of a cross-sectional view of a shampooer of the present invention.

FIG. 2 is a representation of a shampooer with a bristle attachment and a massager attachment.

FIG. 3 is a representation of the shampooer.

FIG. 4 is a representation of the shampooer.

FIG. 5 is a representation of a portion of the housing.

### DETAILED DESCRIPTION

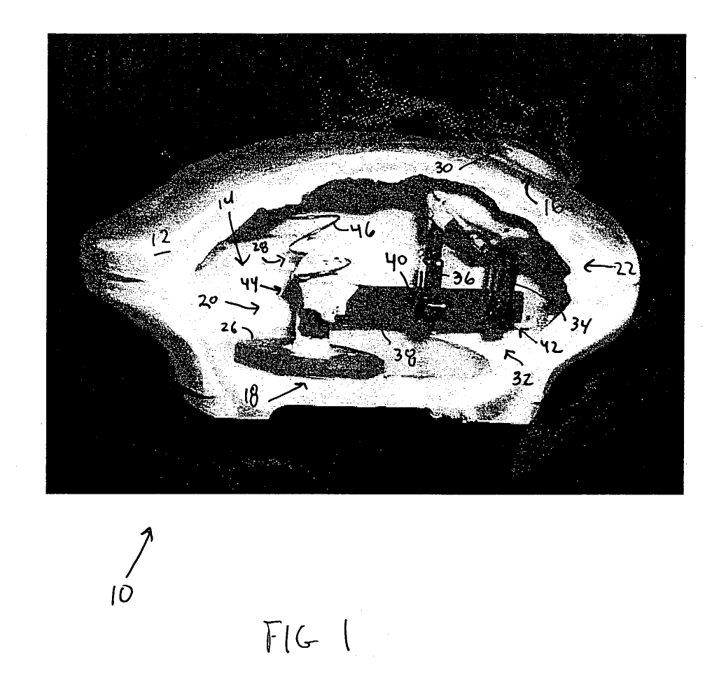

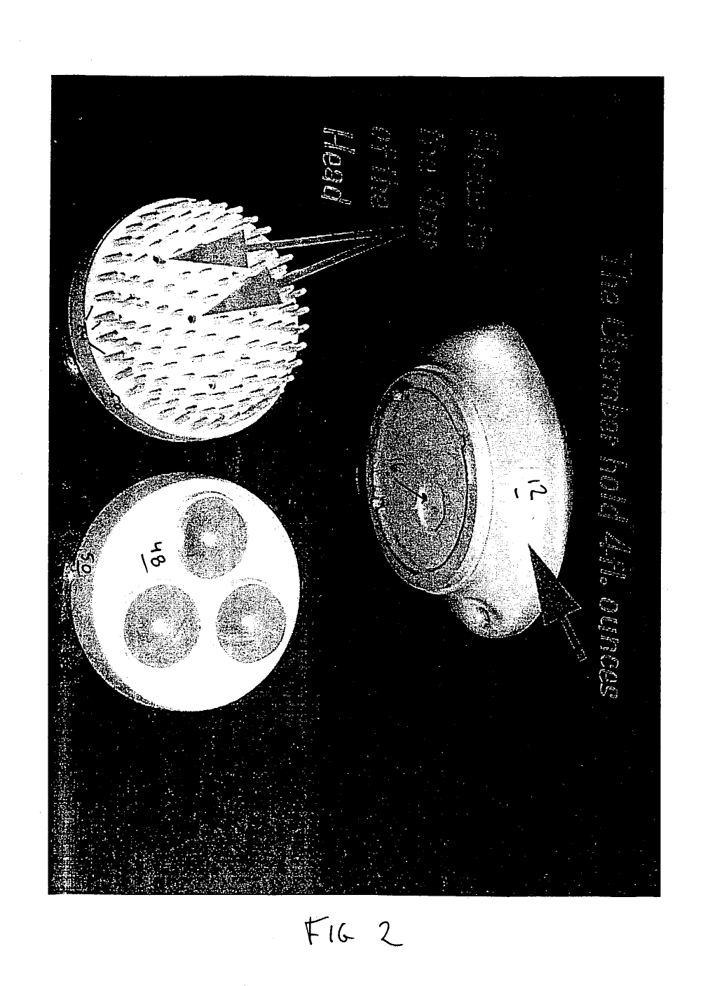

Referring now to the drawings wherein like reference numerals refer to similar or identical parts throughout the several views, and more specifically to FIGS. 1 and 2 thereof, there is shown a shampooer 10 for shampooing hair. The shampooer 10 comprises a housing 12 having a chamber 14 in which fluid is stored, a first hole 16 through which the fluid in the chamber 14 can flow, and at least a second hole 18. The shampooer 10 comprises a door 20 disposed in the chamber 14 over the first hole 16 which closes the first hole 16 when the door 20 is in a closed state and opens the first hole 16 for fluid from the chamber 14 to pass through when the door 20 is in an open state. The shampooer 10 comprises an activator 22 disposed on the housing 12 that extends through the second hole 18 to the door 20, when the activator 22 is in a depressed state, the door 20 is in the open state and when the activator 22 is in an undepressed state, the door 20 is in the closed state. The shampooer 10 comprises a head 50 attached to the housing 12 adjacent the first hole 16 for rubbing the hair. The head 50 can have bristles 24 or be a massager 48.

Preferably, the door 20 includes a flange 26 connected to the activator 22 which seals the first hole 16 closed when the door 20 is in the closed state and opens the first hole 16 when the door 20 is in the open state.

The door 20 preferably includes a forcing mechanism 28 connected to the activator 22 and the housing 12 which is compressed by the activator 22 when the activator 22 is in a depressed state, and applies a restoring force to the flange 26 which causes the flange 26 to return to and remain in the close state when the activator 22 is in an undepressed state. Preferably, the activator 22 includes a button 30 disposed in the housing 12 and a stem 32 that extends from the button 30 through the second hole 18 to the door 20.

The stem 32 preferably includes a first post 34 that extends from the button 30 into the housing 12, and a shaft 38 connected to the first post 34 and the door 20. Preferably, the stem 32 includes a second post 36 connected to the shaft 38 and the housing 12 that serves as a pivot point 40 for the shaft 38 when the button 30 is depressed, allowing the first post to move down and lower the first end 42 of the shaft 38 while the second post 36 holds the shaft 38 and while a second end 44 of the shaft 38 rises to raise the flange 26. The forcing mechanism 28 preferably includes a spring 46.

The present invention pertains to a method for shampooing hair. The method comprises the steps of depressing a button 30 disposed on a housing 12 to a depressed date which causes a stem 32 that extends from the button 30 through a second hole 18 in the housing 12 through a chamber 14 in the housing 12 to a door 20 to move the door 20 to an open state and open a first hole 16 in the chamber 14. There is the step of introducing soap into the chamber 14 through the first hole 16. There is the step of releasing the button 30 causing the button 30 to move to an undepressed state, and the stem 32 to move the door 20 to a closed state which seals the first hole 16 and prevents the soap in the chamber 14 from flowing through the first hole 16. There is the step of placing the housing 12 on the hair. There is the step of depressing the button 30 to move the door 20 to the open state and allow soap in the chamber 14 to flow through the first hole 16 and out to the hair. There is the step of moving the housing 12 against the hair.

Preferably, the depressing step includes the step of depressing the button 30 which causes a first port of the stem 32 to move down and lower a first end 42 of the shaft 38 of the stem 32 so the shaft 38 pivots around a second post 36 of the stem 32 and lifts a second end 44 of the shaft 38, where the second end 44 of the shaft 38 is connected to the door 20 and lifts a flange 26 of the door 20 off of the first hole 16 into the open state and compresses the spring 46 which pushes against the flange 26. The releasing step preferably includes the step of releasing the button 30 which causes the spring 46 to push the flange 26 on to the first hole 16 and into the close state and lower the second end 44 of the shaft 38 while the shaft 38 pivots about the second port, in turn causing the first end 42 of the shaft 38 to move up and push the first port up and move the button 30 into the undepressed state.

In the operation of the invention, and referring to FIGS. 2-4, the shampooer 10 dispenses shampoo and massages it into the scalp with the attached brush head 50. This action creates ample suds and a deep cleaning. The current technique is to use your fingers to rub in the shampoo. This technique cannot produce the scrubbing action that the 180 tines of the brush can achieve. Another benefit is that the dog hairs will become entwined into the tines of the brush and can easily be removed after the brush head 50 becomes full of fur. This reduces the amount of fur that goes down the drain of a tub. The brushing action during shampooing also removes tangles and knots in the fur which is an easier operation while the fur is wet. The final benefit is that the brushing action feels great to the animal, making for a more enjoyable bathing experience.

The operation of the unit is as follows.

1) Remove the brush head 50 by unscrewing the head 50 from the housing 12 of the shampooer 10.

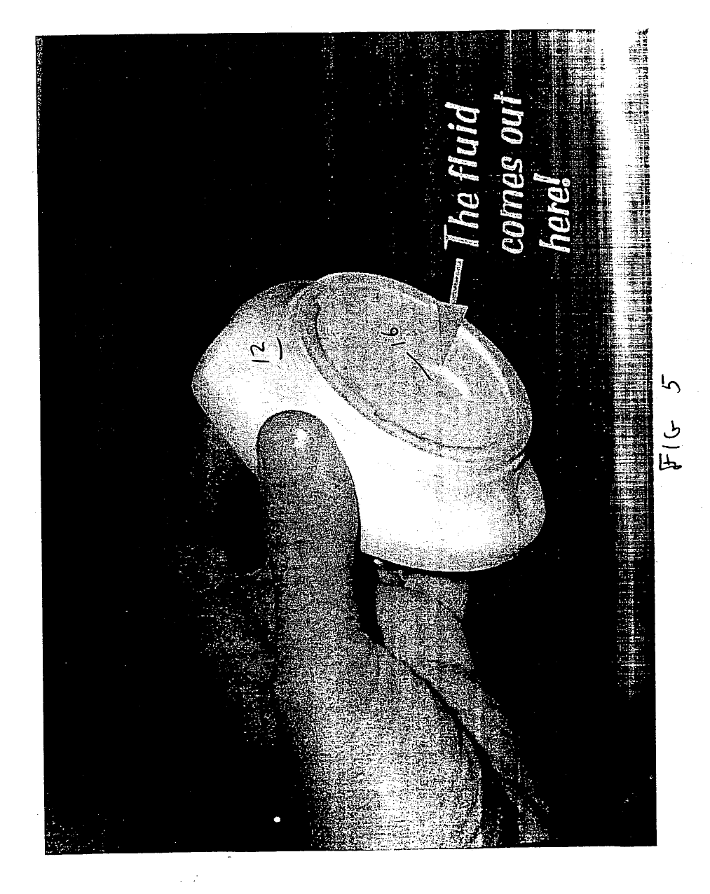

2) Depress the button 30 on the top of the shampooer 10 which opens the trap door 20 on the bottom side of the shampooer 10 housing 12 so fluid escapes through the first hole 16, as shown in FIG. 5.

3) When the door 20 is opened, the shampoo is poured into the hole created by the retracted trap door 20 until the chamber 14 is full.

4) Attach the brush head 50 by screwing the head 50 back on the housing 12.

5) Wet down the animal with water and place the shampooer 10 in your hand (right or left), depress the button 30 on top of the unit while the brush is in contact with the animal fur. This will allow the shampoo to flow into the brush head 50 and thru the holes located in the floor of the brush head 50. The brush head 50 allows water to mix with the shampoo as it flows through the holes.

6) Once the shampoo becomes sudsy, brush the shampoo into the scalp and fur with circular motions.

7) Remove fur gathered into the brush tines by peeling it away from the brush head 50 and discard.

8) The shampooer 10 can hold 4 fluid ounces of shampoo enough for about two washes per animal depending on the size of the animal.

Other uses for the product include human shampooing, a sponge attachment to provide a shower body wash, human massaging and a soft bristle scrub brush attachment to clean objects like a sink, shower or even pots and pans.

Each of these attachments will have similar methods of operating the product with the difference being the type of fluid used in the chamber 14 of the shampooer 10.

With a second shampooer 10, instead of shampoo, use body wash liquid in the chamber 14 and apply the sponge attachment for a great way to cleans the body. Just press the button 30 and the liquid is dispensed into the sponge, rubbing the sponge over the body, creating a foam cleaning. A loofa type sponge for a great exfoliating action can also be used.

The internal operation of the shampooer 10 works as follows. Referring to FIGS. 1 and 2, when the shampooer 10 housing 12 is to be filled, a user depresses a button 30 on the housing 12. By depressing the button 30, the button 30 is placed in a depressed state. As the button 30 is depressed, it moves down a first post 34 that extends from the bottom through a second hole 18 in the housing 12 into the chamber 14 of the housing 12. As the first post 34 moves down, it in turn moves down a first end 42 of a shaft 38 that is disposed in the housing 12. The shaft 38 extends from the first post 34 to a door 20 disposed in the housing 12, with a second post 36 attached to the shaft 38 and the housing 12. The second post 36 acts as a pivot point 40 for the shaft 38 so that as the first end 42 of the shaft 38 moves down, a second end 44 of the shaft 38 moves up as it rotates about the point that the shaft 38 is connected to the second post 36.

When the second end 44 of the shaft 38 moves up, it pulls up a flange 26 of the door 20 that covers and seals the first hole 16 in the housing 12, and also compresses a spring 46 of the door 20 that extends from the second end 44 of the shaft 38 up to the ceiling of the housing 12, since the door 20 is attached to the second end 44 of the shaft 38. With the flange 26 off of the first hole 16, the door 20 is in an open state, and shampoo can be poured into the chamber 14 through the open first hole 16.

When the chamber 14 is filled with the shampoo, the button 30 is released, allowing it to move back into the undepressed state. It moves into the undepressed state from the force of the spring 46 expanding back into its equilibrium position and pushing down against the flange 26 to cause the flange 26 to close and seal the first hole 16 and push down the second end 44 of the shaft 38. When the second end 44 of the shaft 38 moves down, the reverse action that had occurred when the button 30 was depressed now proceeds. The shaft 38 pivots around the point at which it is connected to the second post 36, causing the first end 42 of the shaft 38 to rise. When the first end 42 of the shaft 38 rises, the first post 34 that is connected to the first end 42 also is caused to rise pushing the button 30 back into the undepressed state.

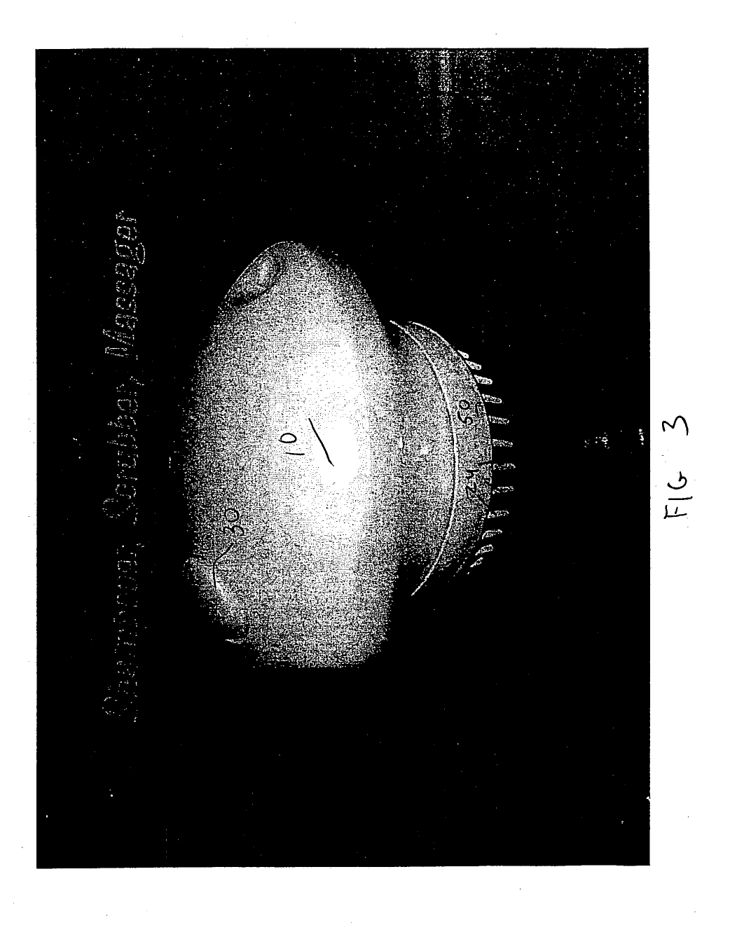

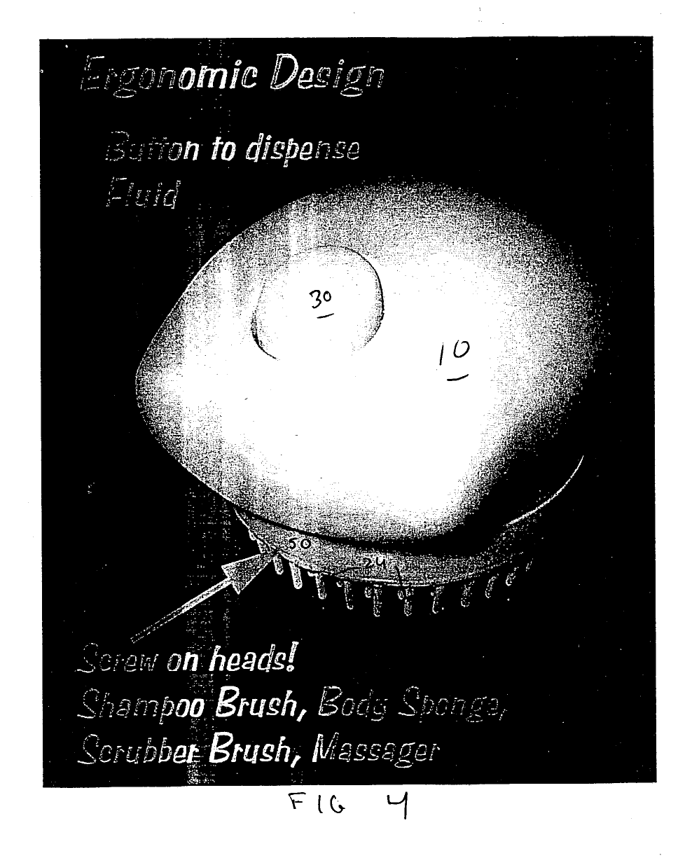

As shown in FIGS. 3 and 4, the housing 12 has an ergonomic design which fits comfortably with the hand and conforms with the hand when the hand of a user grasps the housing 12.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A shampooer for shampooing hair comprising:
a housing having a chamber in which fluid is stored, a first hole through which the fluid in the chamber can flow, and at least a second hole;
a door disposed in the chamber over the first hole which closes the first hole when the door is in a closed state and opens the first hole for fluid from the chamber to pass through when the door is in an open state;
an activator disposed on the housing that extends through the second hole to the door, when the activator is in a depressed state, the door is in the open state and when the activator is in an undepressed state, the door is in the closed state; and
a head attached to the housing adjacent the first hole for rubbing the hair.

2. A shampooer as described in claim 1 wherein the door includes a flange connected to the activator which seals the first hole closed when the door is in the closed state and opens the first hole when the door is in the open state.

3. A shampooer as described in claim 2 wherein the door includes a forcing mechanism connected to the activator and the housing which is compressed by the activator when the activator is in a depressed state, and applies a restoring force to the flange which causes the flange to return to and remain in the close state when the activator is in an undepressed state.

4. A shampooer as described in claim 3 wherein the activator includes a button disposed in the housing and a stem that extends from the button through the second hole to the door.

5. A shampooer as described in claim 4 wherein the stem includes a first post that extends from the button into the housing, and a shaft connected to the first post and the door.

6. A shampooer as described in claim 5 wherein the stem includes a second post connected to the shaft and the housing that serves as a pivot point for the shaft when the button is depressed, allowing the first port to move down and lower a first end of the shaft while the second post holds the shaft and while a second end of the shaft rises to raise the flange.

7. A shampooer as described in claim 6 wherein the forcing mechanism includes a spring.

8. A method for shampooing hair comprising the steps of:
depressing a button disposed on a housing to a depressed date which causes a stem that extends from the button through a second hole in the housing through a chamber in the housing to a door to move the door to an open state and open a first hole in the chamber;
introducing soap into the chamber through the first hole;
releasing the button causing the button to move to an undepressed state, and the stem to move the door to a closed state which seals the first hole and prevents the soap in the chamber from flowing through the first hole;
placing the housing on the hair;
depressing the button to move the door to the open state and allow soap in the chamber to flow through the first hole and out to the hair; and
moving a head of the housing against the hair.

9. A method as described in claim 8 wherein the depressing step includes the step of depressing the button which causes a first port of the stem to move down and lower a first end of the shaft of the stem so the shaft pivots around a second post of the stem and lifts a second end of the shaft, where the second end of the shaft is connected to the door and lifts a flange of the door off of the first hole into the open state and compresses the spring which pushes against the flange.

10. A method as described in claim 9 wherein the releasing step includes the step of releasing the button which causes the spring to push the flange on to the first hole and into the close state and lower the second end of the shaft while the shaft pivots about the second port, in turn causing the first end of the shaft to move up and push the first port up and move the button into the undepressed state.
